(19) United States
(12) Patent Application Publication
(10) Pub. No.: US 2002/0129773 A1
(43) Pub. Date: Sep. 19, 2002

(54) Removing litter from walkways in chicken houses

(76) Inventor: Leon Beiler, Mt. Joy, PA (US)

Correspondence Address: FREDERICK J. OLSSON, P.O. Box 192, WAYNE, PA, 19087, US

(21) Appl. No.: 09/814,473

(22) Filed: Mar. 19, 2001

(51) Int. Cl. A01K 31/04

(52) U.S. Cl. 119/442

(57) ABSTRACT

Methods and apparatus are described for clearing the walkways in chicken houses of litter, and placing the litter on a manure pile so as to cover moist droppings, thereby depriving egg-laying flies of sites for their eggs. The apparatus is powered and highly maneuverable, enabling the farmer to clear the walkways frequently and regularly. Using the methods and apparatus of this invention the fly population in chicken houses is significantly decreased compared to a facility relying on prior art manual shoveling of litter from the walkways.

### PRIOR ART AND OBJECTIVES

This disclosure relates to methods and apparatus for clearing litter from the walkways of chicken houses and conveying same onto the top of a manure pile. Use of the disclosed methods and apparatus to clear the walkways of litter reduces the population of flies in the chicken houses, especially high-rise chicken houses containing large numbers of chickens. Typically, a high-rise chicken house will house from 80,000 to one-quarter million chickens. The control and reduction of the population of flies in the chicken houses has been a long-standing goal of chicken farmers, but a satisfactory solution has not been available in the prior art.

The largest contributor to the fly problem is the generation and storage of large quantities of chicken manure, referred to herein as droppings. The droppings, when moist, provide the flies with a near-ideal place to deposit their eggs. There, the eggs hatch into larva, which then change to pupa, which then mature into winged flies. The mature flies contaminate the chicken eggs by depositing specks of dung on the egg shells. These fly specks are difficult to remove and the eggs so contaminated may have reduced marketplace value. In addition to causing the fly-speck problem, the fly population may contribute to the spread of diseases among the chicken flock. Therefore, the chicken farmers are searching for better, more economical ways to control the fly population in the chicken houses and to improve the cleanliness of the chicken houses.

Moist droppings are a near-ideal place for flies to lay eggs, but when the droppings are dry and hardened, then the droppings are no longer an attractive site for the egg-laying flies. Generally, flies do not lay eggs on dry droppings. Thus, it is desirable to deprive the flies access to moist droppings.

Egg farmers have endeavored to keep the chicken houses free of moist droppings by daily cleaning the floors and removing the moist droppings. While this method of fly control is effective, it is also prohibitively expensive. As a result, daily cleaning is seldom done.

In a modern high-rise chicken house the chicken cages 2 are arranged in rows above a concrete floor as depicted in FIG. 1. The droppings from the cages form piles of manure 1, while the adjacent aisles or walkways 3 contain mostly dry matter, including feathers, spilled feed, and the dry edges 4 of the manure piles. It has been found that a reduction in the population of flies can be achieved if the dry matter which has accumulated in the aisles is transferred onto the top of the adjacent manure piles 1. This covering of dry matter prevents the flies from reaching the moist droppings and thereby deprives the flies of a productive site for laying eggs.

It has been common practice to manually clear the aisles of dry matter by using hand-held implements such as shovels or pitchforks. This is a labor-intensive task which is typically performed about once per week. The high labor costs and low productivity have prevented more widespread use of this manual method.

In the prior art it is known to plow the top of the manure pile in an attempt to cover the moist fresh droppings with manure located deep within the manure pile with the expectation that the plowed manure will be dry. This method consumes excessive power in plowing the manure pile and thereby increases production costs.

Thus, one objective of this instant invention is to provide powered apparatus which scoops-up the litter in the aisles and transfers same onto the top and center of the manure pile so as to cover the moist droppings with a layer of dry matter.

Another objective is apparatus capable of rapidly traversing the aisles, scooping up the litter and transferring same to the top of the manure pile.

Another objective is to provide a method for reducing the fly population in chicken houses, wherein the apparatus of this invention is used regularly and frequently to clear the walkways of litter and deposit same onto a manure pile.

### BRIEF DESCRIPTION OF THE INVENTION

Powered apparatus is provided comprising a power source such as an internal combustion engine, or an electric motor connected to a power source such as batteries or electrical mains. The preferred apparatus is ridden by an operator who drives the apparatus up and down the aisles successively so as to clear all aisles. The apparatus has a scraping device for loosening the bond of the litter to the floor, and a sweeping device such as an auger for moving or sweeping the litter into a collector on the powered apparatus. An elevating device is provided for lifting the litter in the collector to a position over the center of the manure pile; and a spreader for distributing the elevated litter along the top surface of the manure pile in a layer of substantially uniform thickness.

In operation, an operator drives the apparatus up and down the aisles or walkways at a speed of the order of 5 miles per hour, or more or less as conditions permit. Using the disclosed methods and apparatus a single operator can clear the aisles of litter and transfer same to the top of the manure pile in a uniform layer at a very rapid rate. For example, a chicken house containing 100,000 chickens can be so treated in about 30 minutes time. This is about one-fortieth the time required for a single worker to manually accomplish the same task. Further, the manual method does not yield a substantially-uniform layer thickness of shoveled dry matter and the reduction in the fly population is lower than can be realized using the disclosed apparatus.

The increased productivity achievable using the disclosed apparatus allows the litter to be transferred to the top of the adjacent manure pile at more-frequent time intervals, and as a result the fly population is significantly reduced when compared to manual shoveling.

The disclosed method includes the steps of using a powered conveyance to pick-up the litter in the aisles or walkways; elevating the picked-up litter to a position above the top of the adjacent manure pile; and spreading the elevated litter along the top of the manure pile, to thereby cover the top surface of the manure pile with a layer of the litter which is substantially uniform in thickness, to thereby cover the moist droppings with a layer of dry matter.

This brief description of the invention is augmented by the drawings, the detailed descriptions, and the claims which follow.

### BRIEF DESCRIPTION OF THE DRAWINGS:

FIG. 1 is a schematic representation of the placement of the chicken cages, aisles or walkways, and manure piles in a high-rise chicken house.

FIG. 2 is a cross sectional drawing showing the shape of a manure pile at several stages of pile height.

FIG. 3 is a perspective drawing of the preferred apparatus of this instant invention, as viewed from the left-front.

FIG. 4 is a perspective drawing of the apparatus as viewed from the left-rear.

FIG. 5 is a perspective drawing of the apparatus of this invention as viewed from the front.

FIG. 6 shows the details of the pick-up auger.

FIG. 7 is a front elevation showing the elevating auger.

### DETAILED DESCRIPTION

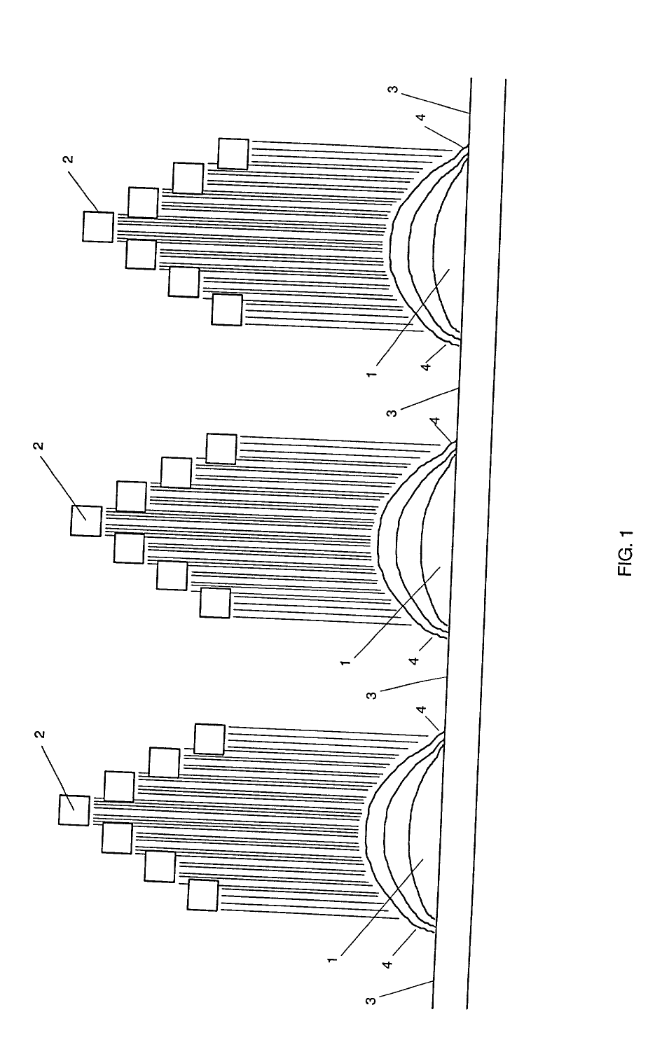

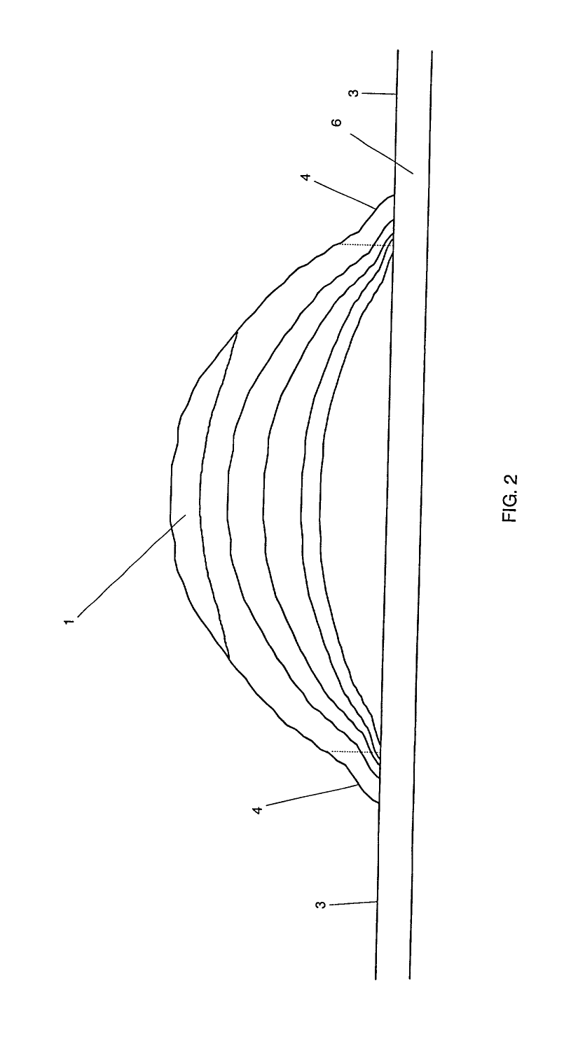

Reference is made to FIG. 1, which shows the arrangement of chicken cages, manure piles and aisles or walkways in a typical high-rise chicken house in widespread use. Typically, the manure piles left by the former flock of chickens have been removed from the chicken house prior to the introduction of a new flock. Over a period of several months the manure pile increases in height and width as shown in FIG. 2. As the pile height increases the droppings ferment and the internal temperature of the manure pile rises, and the edges 4 of pile 1 dry out and form an unproductive habitat for fly egg-laying. The center of pile 1 contains more droppings, and is more moist, and is the preferred location for the flies to deposit eggs.

Aisles 3 contains dry matter 4 which is the edge of the manure pile 1. Additional dry matter accumulates in the aisles as it falls from the cages, including chicken feathers and spilled feed. The disclosed apparatus is capable of scraping and picking-up the edges of the manure pile adjacent to the walkways. This clearing step supplies additional dry matter and maintains a wide walkway for improved personnel safety. If so desired, additional matter such as sawdust or larvacide may be spread onto the walkways and then picked-up and transferred to the manure pile by the apparatus of this invention. As used in this disclosure, the term litter means the dry matter falling from the overhead cages onto the walkways and other added matter such as sawdust.

The apparatus of this invention is driven down the aisles and picks up the litter from the walkways, elevates same to a position above the top of the manure pile 1 and distributes the picked-up material along the top of pile 1. The concentration of moist droppings is greatest along the center of the manure pile, and the litter spread along the top surface covers the moist droppings with feathers and other litter. The litter so spread covers the moist droppings with a layer of dry matter, and the moist droppings are no longer accessible to flies searching for egg-laying sites. Further, moist droppings covered by dry litter may contain fly eggs deposited prior to covering with litter. The dry litter dehydrates the fly eggs and any larva or pupa resident in the covered droppings may not survive. As used in this disclosure the term conveyance is used to denote powered apparatus which conveys the litter from the walkways to the top of a manure pile.

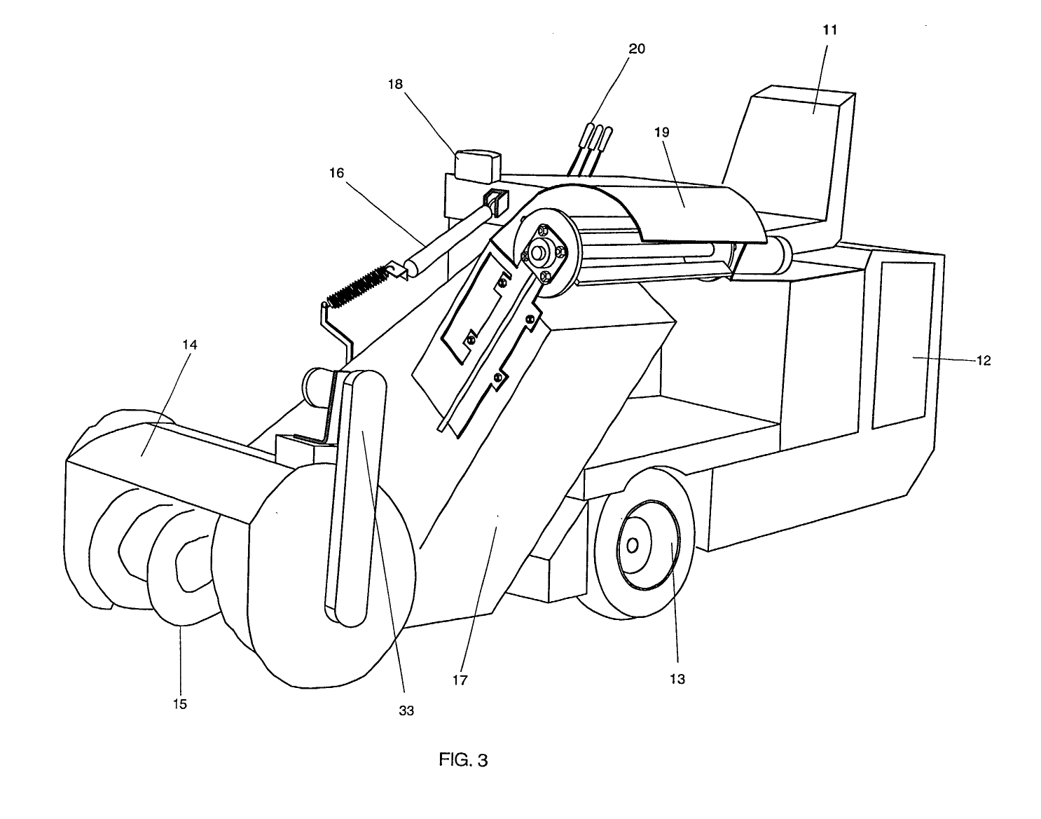

Reference is made to FIG. 3, which shows the preferred apparatus for practicing the methods of this instant invention. The operator sits on seat 11 when using the apparatus, and uses hydraulic control levers 20 to drive the vehicle and to position the scraper and collector a distance from the floor 6. Cover 12 protects a gasoline-powered internal combustion engine having a power rating of about 13 horsepower. Wheel 13 is a drive wheel and is powered by a hydraulic motor. The gas powered engine is coupled to a hydraulic pump, which supplies the power needed to propel and control the apparatus. The apparatus has a “zero turning radius” to provide the required manuverability.

Collector 14 temporarily stores the picked-up litter until it is moved to the elevator 17. The elevated litter is discharged from the apparatus and onto the manure pile via opening 19. Auger 15 forces the loosened litter into collector 14. Auger 15 has both a right-hand and left-hand section of flights, so as to channel the picked-up litter to a central location preparatory to being elevated by the elevating apparatus 17.

Hydraulic cylinder 16 raises and lowers the collector and auger assemblies so as to control the clearance between the floor and auger 15. Headlamp 18 provides light for use in the darkened chicken houses.

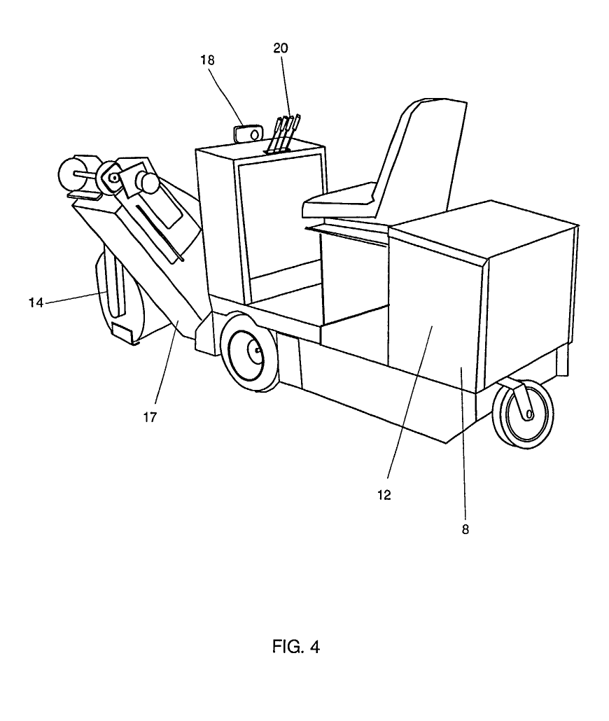

Reference is made to FIG. 4, a perspective drawing viewed from the left-rear. Internal-combustion engine 8, which is located behind cover 12 provides the power to propel and control the apparatus in traversing the aisles , picking-up the litter, elevating the litter, and depositing same onto the top of an adjacent manure pile. An emergency switch is located under the operator's seat so as to stop the engine should the operator leave the seat. Levers 20 allow the operator to raise or lower the pick-up auger and elevator assembly, to move forward or in reverse, and to steer the vehicle. Elevator 17 is preferably a conveyor having paddles which move the picked-up litter to a position which is above the top of the manure pile so that the discharged litter falls onto the pile along the top-center of the manure pile. Collector 14 houses the pick-up auger and passes the picked-up litter to the elevator.

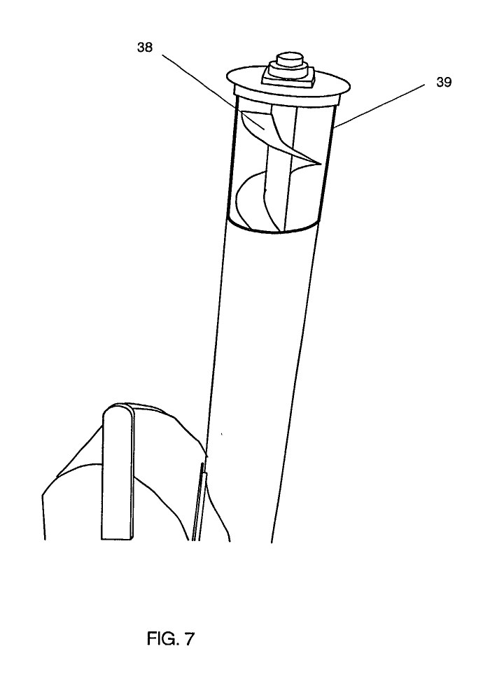

The elevator 17 may alternately consist of an elevator auger 38 which lifts the litter from the collector, and moves the litter to a location over the pile, where the litter is discharged along the top of the pile. As shown in FIG. 7, Pipe 39 mounts the elevator auger 38 and conducts the litter to the discharge opening.

Experiments were performed using forced air to elevate and discharge the litter from the apparatus, but this approach was abandoned due to the excessive dust which was generated, and the loss of accuracy in placement of the litter onto the pile. In addition, using forced air to elevate and spread the picked-up litter resulted in reduced layer uniformity in thickness along the top of the manure pile.

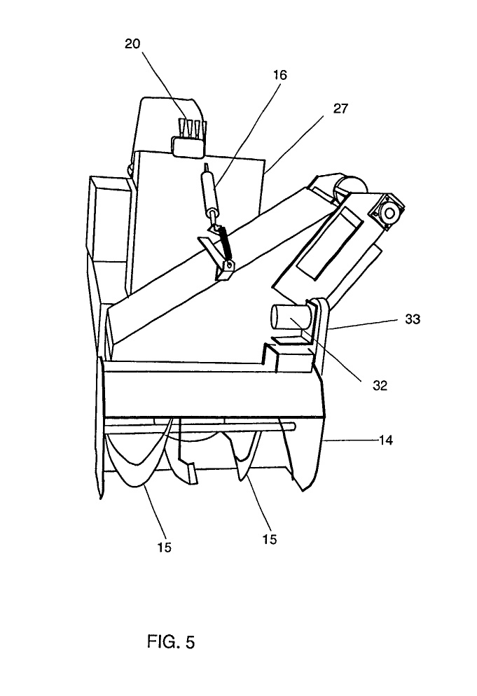

Reference is made to FIG. 5, which shows a front perspective of the apparatus of this invention. Collector 14 houses pick-up auger 15. Hydraulic motor 32 powers the pick-up auger 15 by a chain which is located behind cover 33. Console 27 contains controls 20 and a manifold containing hydraulic fluid used to control the operation of the vehicle and the powered components. Hydraulic cylinder 16 is activated by a control lever 20 to raise or lower the assembly which includes the collector, the pick-up auger and the elevator.

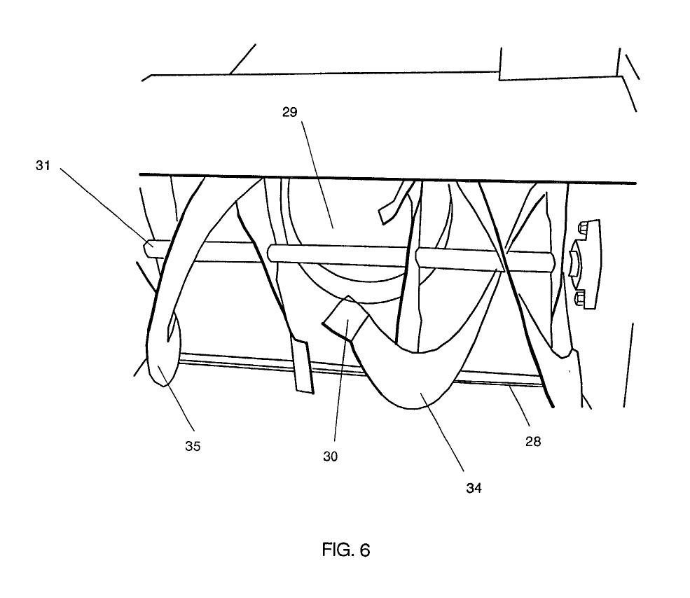

Reference is made to FIG. 6, which shows the pick-up auger in greater detail. Auger shaft 31 is powered by hydraulic motor 32 via a roller chain protected by cover 33. Flights 34 and 35 are attached to auger shaft 31. In operation, scraper 28 slides along the floor and thereby breaks the bond of the litter to the floor. The litter is pushed ahead of the scraper to form a piled-up portion which is contacted by the flights of the pick-up auger 15, and swept into collector 14. The picked-up litter is moved through opening 29 to the elevator assembly. Pick-up auger 15 has both right-hand 34 and left-hand 35 flights in order to move the picked-up litter into opening 29. Auger paddle 30, which is located in front of opening 29, also assists in moving the litter through opening 29. Thus, the right-hand and left-hand portions of auger 15 serves to move the picked-up litter toward opening 29 irrespective of its initial location with respect to opening 29.

The elevator may be comprised of an auger, as shown in FIG. 7. In this embodiment, the elevator auger is surrounded by a pipe, such that the lower end of the elevator auger is connected to the collector. The pipe surrounding the elevator auger is positioned so as to move the litter to a position which is above the top of the manure pile and the litter is spread along the center of the manure pile so as to cover the moist droppings present there, with a layer of dry matter which is substantially uniform in thickness.

The methods and apparatus of this invention are especially effective when the dry matter is cleared from the aisles and stacked on an adjacent manure pile frequently beginning when the manure pile is just forming, and continuing regularly as the manure piles increase in size. The egg-laying flies are thereby deprived of a productive site on which to deposit eggs, and the fly population is greatly reduced compared to a similar facility using manual shoveling methods or insecticides to control the fly population. A reduction in the quantity of insecticides is highly desirable so as to avoid potential pollution of the environment. The preferred embodiment of apparatus to practice the methods of this invention are described in the Detailed Description of this specification. One skilled in the art may use other components in order to practice the invention, within the spirit of this invention. For example, experiments were conducted in which the operator walked behind the powered apparatus, but severe operator fatigue was experienced and the walk-behind method was abandoned in favor of apparatus on which the operator rides.

What I claim is:

1. Apparatus for clearing litter from walkways in chicken houses and placing said litter on a manure pile commprising;
means for loosening said litter from said walkways;
pick-up means for loading said loosened litter onto a conveyance;
elevating means for raising said picked-up litter to a height above the height of said pile; and
spreading means for distributing said raised litter along the top of said pile;
powering means for propelling said conveyance along said walkways;
powering means for said loosening means, pick-up means, elevating means and spreading means;
control means for operator use in driving said conveyance and raising and lowering the scraper height above the floor;

2. Apparatus as in claim 1 in which said pick-up means comprises a sweeper to sweep said loosened litter onto said conveyance.

3. Apparatus as in claim 2 in which said sweeper comprises an auger.

4. Apparatus as in claim 3 in which said auger has flights having both right-hand and left-hand sections.

5. Apparatus as in claim 1 in which said elevating means comprises a conveyor.

6. Apparatus as in claim 1 in which said elevating means comprises an auger.

7. Apparatus as in claim 1 in which said powering means comprises an internal-combustion engine.

8. Apparatus as in claim 1 in which said powering means drives a hydraulic pump.

9. Apparatus as in claim 8 in which said hydraulic pump supplies pressurized hydraulic fluid to said control means.

10. Apparatus as in claim 1 in which said powering means comprises an electric motor.

11. The method of clearing litter from walkways in chicken houses and depositing the litter so cleared on the top of a manure pile, including the steps of:
picking-up said litter from said walkways, and depositing said litter into a collector;
moving and elevating the litter in said collector to a location over the manure pile; and
spreading said elevated litter along the top of said manure pile,
wherein the apparatus for clearing the walkways and stacking the picked-up litter is powered.

12. The method of claim 11 in which the step of picking up said litter includes the steps of:
scraping the litter from the floor of said walkway;
sweeping the litter from the floor into a collector.

13. The method of claim 12, in which said sweeping step is effected using an auger.

14. The method of claim 13 in which said auger has flights having both right-hand and left-hand sections.
